(19) United States
(12) Patent Application Publication
(10) Pub. No.: US 2019/0047703 A1
(43) Pub. Date: Feb. 14, 2019

(54) System and Method for Locally Precise Application of Solids and Liquids and Mixtures Thereof in Agriculture and Forestry

(71) Applicant: Thomas Wunsche, Ilmmunster (DE)

(72) Inventor: Thomas Wunsche, Ilmmunster (DE)

(21) Appl. No.: 16/075,362

(22) PCT Filed: Jan. 20, 2017
(86) PCT No.: PCT/DE17/00008

§ 371 Date: Aug. 3, 2018

(30) Foreign Application Priority Data
Feb. 5, 2016 (DE) 10 2016 001 353.2

(51) Int. Cl. B64C 39/02; G05D 1/10; A01M 9/00; A01M 7/00; A01M 11/00

(52) U.S. Cl. CPC B64C 39/024; G05D 1/102; A01M 9/00; B64C 2201/128; A01M 11/00; B64C 2201/145; B64C 2201/027; A01M 7/0089

(57) ABSTRACT

The present invention relates to a system for locally precise application of substances to useful areas of farmland and woodland and a corresponding method. The system comprises at least one multiple rotary wing aircraft, which contains at least one electronic control device for controlling the flight movements, which steers the multiple rotary-wing aircraft autonomously on predefined flight paths. The electronic control device contains at least one processing unit, at least one receiver for signals of a global satellite navigation system for position determining and an inertial measurement unit for detecting movement data of the multiple rotary-wing aircraft. The processing unit calculates the data of the receiver according to the method of real-time kinematics with the data of a base station and with the measured data of the inertial measurement unit for improving the accuracy of the position measurement data so that the electronic control device can sufficiently accurately steer the multiple rotary-wing aircraft to apply substances to farmlands.

The present invention relates to the application of substances such as, for example, liquid or solid plant protection agents, liquid or solid fertilizers or seed, to agricultural areas by means of an unmanned aircraft having a plurality of individually driven rotors (multiple rotary-wing aircraft), which are arranged such that they generate sufficient lift as a result of the thrust produced in order to keep and move the aircraft in the air. The control of the aircraft is carried out via the variation of the rotational speed and therefore the thrust of each rotor by using specific control procedures, which are carried out by an electronic control unit located on the aircraft.

In addition, the present invention relates to the use of a global satellite navigation system (GNSS) and inertial sensors by the electronic control installed on the aircraft for position determination.

In modern agriculture, ground-based traveling spraying devices usually spray plant protection and pest control agents onto the ground or the plant population with the aid of spray nozzles.

Multiple rotary-wing aircraft are likewise already used for applying plant protection agents. They apply liquid plant protection agents by means of spray nozzles on the aircraft to the ground or the plant population. They fly independently over predefined distances either autonomously with the aid of an electronic control and GNSS or are steered by a pilot by radio remote control.

Fungal infection on the useful plants can often be combated most efficiently shortly after the causative period of rain. Early treatment following intense rainfall is problematical on account of the lack of navigability of softened ground with traveling field sprayers. Non-optimal application times lead to an increase in mycotoxins in the useful plants. Exceeding the limiting values rules out use as food or feedstuffs. The multiple rotary-wing aircraft, on the other hand, can be used with any arbitrary nature of the ground or the plant population on the agricultural area.

The treatment of agricultural areas with plant protection agents in the spraying method by traveling field sprayers is usually carried out by lining up parallel processing strips with one another without any gaps, with a working width resulting from the design. The most uniform application density of the plant protection agent over the entire working width is intended. Each spray nozzle sprays a partial width, but not in a manner sharply delimited relative to adjacent partial widths, since this is technically not possible. The falling gradient of the application quantity of the respective outermost spray nozzle at the edges of the entire processing strip adds to the application quantity of the outermost spray nozzle of the adjacent processing strip in the overlap area, so that fluctuations in the application quantity arise there, depending on the track accuracy of the processing strips relative to one another.

Based on the total working width of typically 10 m to 40 m in the case of traveling field sprayers, fluctuations are tolerable, since the overlap area makes up only a very small proportion of the total area. On the other hand, given only for example 1.5 m working width of an unmanned multiple rotary-wing aircraft for spraying plant protection agents, the track accuracy of the processing strips relative to one another must lie in the region of a few centimeters in order to keep the proportion of inaccurately dosed plant protection agent in the overlap areas between the processing strips, based on the total area, as low as in the case of a traveling field sprayer. The positioning accuracy required for this purpose presupposes a still higher position measuring accuracy. Comparable conditions for the overlap areas between processing strips also apply to the application of solids, for example fertilizers, by means of a spreading device.

Global satellite navigation systems with real-time kinematics (RTK), according to the current prior art, offer a position measuring accuracy of a few centimeters but with low availability, since the phase angle of the satellite radio signal cannot be assigned unambiguously to an actual multiple of the wavelength (integer ambiguity), and thus permanent dynamic position determination with a moving antenna cannot be carried out reliably.

Position determination by inertial navigation for a moving aircraft, for example by double integration of accelerations, is continuously possible but the deviations from the actual position as a result of integration of measurement errors after a few seconds are too high for the given practical application on an aircraft.

By linking RTK measured values with the measured values from inertial sensors, the integration errors of the acceleration measured values are corrected regularly, and the availability and reliability of centimeter-precise RTK-GNSS positions are improved.

The present invention, a multiple rotary-wing aircraft for applying plant protection agents with position determination as a result of linking RTK measured values with the measured values from inertial sensors by an evaluation unit located on the aircraft, permits high availability of accurate position data and thus application of plant protection agents with an accuracy of a few centimeters in a continuous process.

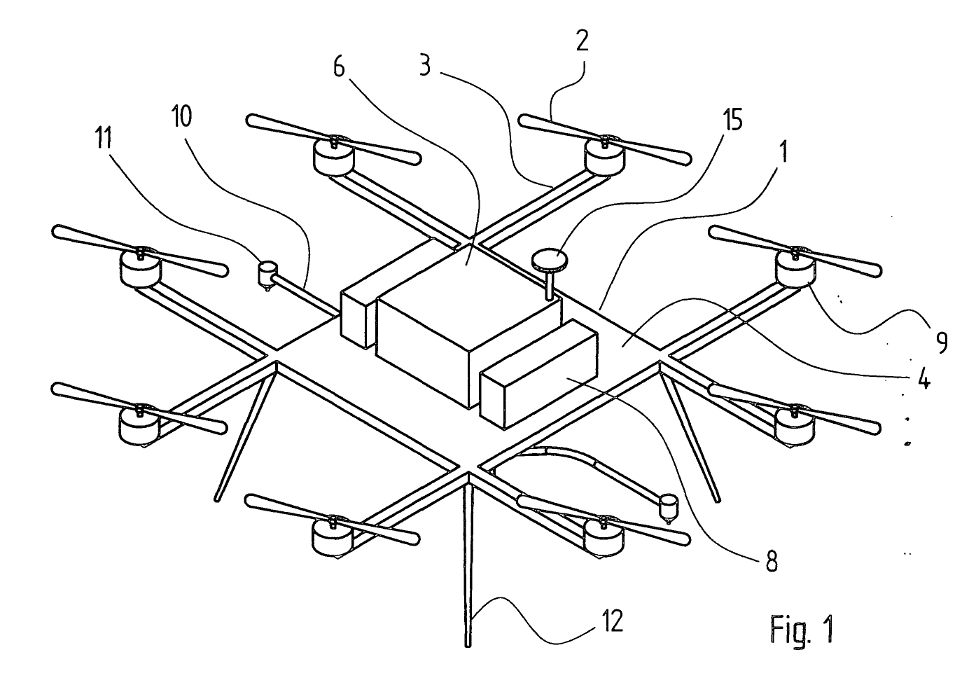

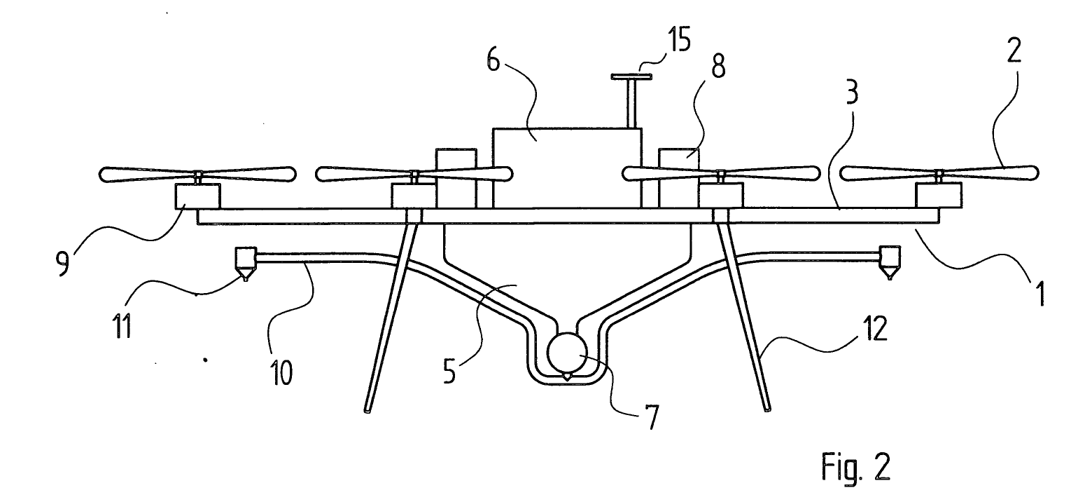

In an embodiment according to FIG. 1 and FIG. 2, the multiple rotary-wing aircraft 1 has eight individually electrically driven rotors 2, which are fixed to a rod assembly 3. In the center of the rod assembly, the following are fitted on a mounting surface 4
a storage container 5 for substances to be applied,
an electronic control device 6,
a delivery unit 7 for substances to be applied, for example a pump, accumulators 8 for supplying power to the rotary drives 9, the electronic control device 6 and the pump 7,
distribution lines 10 and nozzles 11 for the substances to be applied, and landing gear 12.

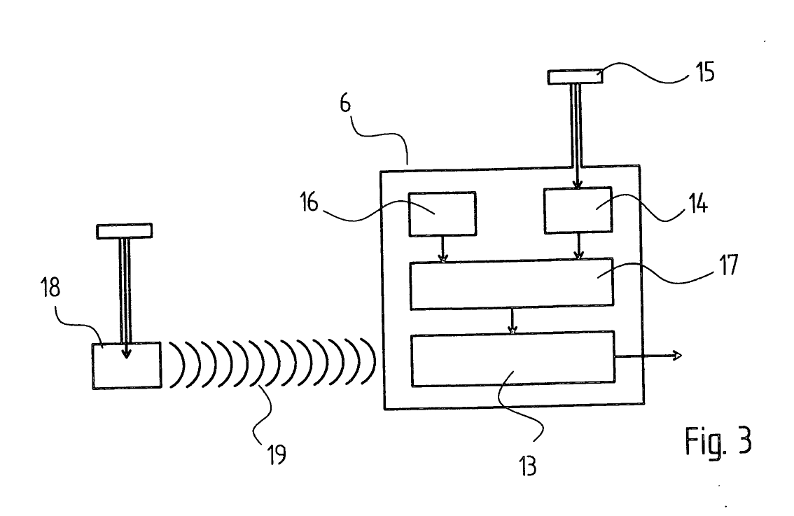

In an embodiment according to FIG. 3, the electronic control device 6 contains
a control unit 13 for generating control commands for the multiple rotary-wing aircraft,
a receiver 14 with antenna 15 for signals from global satellite navigation systems,
an inertial measuring unit 16 for acquiring movement data of the multiple rotary-wing aircraft, and
a processing unit 17 for combining the satellite signals and the movement data, said processing unit receiving the data required to calculate the real-time kinematics from a base station 18 via radio 19.

In a preferred embodiment of the invention, a Kalman filter combines the measured values from the inertial sensors and the raw data
pseudo length,
carrier phase,
Doppler shift
   from a GNSS receiver and a base station to form a precise and reliable position. As a result, the drift of the inertial sensors is compensated and, likewise, the range of the possible solutions of the integer ambiguity in the position determination in accordance with the real-time kinematics method is highly restricted.

What is claimed:

1. A method for locally precise application of solids and liquids and mixtures thereof in agriculture and forestry, which permits sufficiently precise positioning for processing connecting tracks and/or for coordinate-controlled individual plant treatment, said method comprising the steps of:
providing at least one multiple rotary-wing aircraft-having inertial sensors and a receiver for receiving signals from a global satellite navigation system attached thereto;
positioning said aircraft precisely by means of position determination by combining measured values from said inertial sensors and measured values from said receiver for signals from global satellite navigation systems, using real-time kinematics; and
using said aircraft to apply said solids, liquid or mixtures to at least one plant.

2. The method as claimed in claim 1, wherein said receiver used is a single-frequency receiver.

3. The method as claimed in claim 1, wherein said inertial sensors used are sensors with which the linear acceleration in three linearly independent spatial directions and the rotational speeds about three linearly independent axes of rotation are determined.

4. The system and method as claimed in claim 1, including the additional step of providing at least one sensor for collecting measured data from magnetic field and/or ultrasound and/or air pressure; are combined and used to further improve the position determination.

5. The method as claimed in claim 1, further comprising the step of using the data from a global satellite navigation system to correct measuring errors of said inertial sensors, wherein this data can be both pure position information and also measured values such as pseudo length, carrier phase and Doppler shift, and also the inertial navigation is used to improve the solution finding of the real-time kinematics.

6. The method as claimed in claim 1, further including the step of using at least one Kalman filter to combine the data from the satellite navigation and the data from the inertial navigation.

7. The method as claimed in claim 1, further including the step of providing an electronic processing unit on said aircraft which carries out at least part of the data processing steps.

8. The method as claimed in claim 1, further comprising the step of operating said multiple rotary-wing aircraft to autonomously fly predefined paths in space at predefined speeds.

9. The method as claimed in claim 1, further including the step of modifying a flight path for said aircraft on the basis of distance measurements to the ground or to the plant population.

10. The method as claimed in claim 1, wherein said substance to be applied is plant protection agent or pest control agent or fertilizer or seed or a mixture thereof.

11. The method as claimed in claim 1, further including the step of automatically feeding power, operating substances and substances to be applied to the multiple rotary-wing aircraft and/or replaced.
